(19) United States
(12) Patent Application Publication
(10) Pub. No.: US 2010/0123009 A1
(43) Pub. Date: May 20, 2010

(54) HIGH-RESOLUTION INTERPOLATION FOR COLOR-IMAGER-BASED OPTICAL CODE READERS

(75) Inventor: Craig D. Cherry, Eugene, OR (US)

Correspondence Address: DATALOGIC - STOEL RIVES LLP;C/O STOEL RIVES LLP, 900 SW 5TH AVENUE, SUITE 2600, PORTLAND, OR, 97204, US

(73) Assignee: Datalogic Scanning Inc., Eugene, OR (US)

(21) Appl. No.: 12/611,869

(22) Filed: Nov. 3, 2009

Related U.S. Application Data
(60) Provisional application No. 61/116,425, filed on Nov. 20, 2008.

(51) Int. Cl. G06K 7/12

(52) U.S. Cl. 235/469

(57) ABSTRACT

An optical code reader includes a color image sensor array having first and second sets of pixels arranged along multiple parallel axes of a first axes group and multiple parallel axes of a second axes group transverse to the first axes group. The pixels of the first set produce data representing sensed light intensity values. In one configuration, the optical code reader includes a single-axis interpolator to produce interpolated intensity values that correspond to selected locations of pixels of the second set. The single-axis interpolator is operable to produce an interpolated intensity value for a selected location by using only intensity values sensed by pixels of the first set that share an axis of the first axes group with the selected location.

### RELATED APPLICATIONS

This application claims benefit under 35 U.S.C. §119(e) of U.S. Provisional Application No. 61/116,425, titled “High-Resolution Interpolation for Color-Imager-Based Optical Code Readers,” filed Nov. 20, 2008, the entire contents of which is incorporated herein by reference.

### TECHNICAL FIELD

The field of this disclosure relates generally to imaging and more particularly, but not exclusively, to systems and methods for reading optical codes.

### BACKGROUND INFORMATION

Optical codes encode useful, optically-readable information typically about the items to which they are attached or otherwise associated. Perhaps the best example of an optical code is the bar code. Bar codes are ubiquitously found on or associated with objects of various types, such as the packaging of retail, wholesale, and inventory goods; retail product presentation fixtures (e.g., shelves); goods undergoing manufacturing; personal or company assets; and documents. By encoding information, a bar code typically serves as an identifier of an object, whether the identification be to a class of objects (e.g., containers of milk) or a unique item (e.g., U.S. Pat. No. 7,201,322). A typical linear or one-dimensional bar code, such as a UPC code, consists of alternating bars (i.e., relatively dark areas) and spaces (i.e., relatively light areas). In a UPC code, for example, the pattern of alternating bars and spaces and the widths of those bars and spaces represent a string of binary ones and zeros, wherein the width of any particular bar or space is an integer multiple of a specified minimum width, which is called a “module” or “unit.” Thus, to decode the information, a bar code reader must be able to reliably discern the pattern of bars and spaces, such as by determining the locations of edges demarking adjacent bars and spaces from one another, across the entire length of the bar code.

Linear bar codes are just one example of the many types of optical codes in use today. Higher-dimensional optical codes, such as, two-dimensional matrix codes (e.g., MaxiCode) or stacked codes (e.g., PDF 417), which are also sometimes referred to as “bar codes,” are also used for various purposes.

Different methods and types of optical code readers are available for capturing an optical code and for decoding the information represented by the optical code. For example, image-based optical code readers are available that include imagers, such as charge-coupled devices (CCDs) or complementary metal oxide semiconductor (CMOS) imagers, that generate electronic image data that represent an image of a captured optical code. Image-based optical code readers are used for reading one-dimensional optical codes and higher-dimensional optical codes. Because optical codes most often include dark and light patterns (e.g., black and white) that represent binary data, imagers of image-based optical code readers are typically monochrome so that uniform sensitivity for each pixel of the imager is achieved.

Common imagers made for image capturing devices, such as still cameras and video cameras, however, are primarily color imagers—not monochrome. Because imagers made for many image capturing devices are color, color imagers are generally made in higher volume and have become more widely available and may be less expensive than monochrome imagers. Common color imagers include a color filter array placed over pixel sensors arranged in a grid of rows and columns. A typical color filter pattern is the Bayer pattern 100 shown in FIG. 1 and described in U.S. Pat. No. 3,971,065 to Bayer. The Bayer pattern 100 includes red filters (corresponding to red (R) pixels 102), green filters (corresponding to green (G) pixels 104), and blue filters (corresponding to blue (B) pixels 106) that pass, respectively, red, green, and blue wavelengths of light. Each pixel of the color imager outputs data representing only a red, green, or blue intensity value, and, thus, each pixel contains only one-third of the total color data for the pixel location. To create a full-color image, still cameras and video cameras use demosaic algorithms to determine red, green, and blue luminance information for each pixel location. For example, a bilinear interpolation method is known in which a green intensity value is generated for the location of red pixel 102a by calculating the mean intensity value of the four adjacent green pixels 104a, 104b, 104c and 104d. Because the above-described bilinear interpolation method results in visible artifacts, other more complicated interpolation methods have been used for still cameras and video cameras such as bicubic interpolation and adaptive algorithms.

Some image-based optical code readers have included color imagers, but the present inventor has recognized that interpolation methods used with color-imager-based optical code readers degrade spatial resolution of optical code images making it difficult to detect accurately edge locations of optical codes. For example, a typical color-imager-based optical code reader that has the same number of total pixels as a monochrome-imager-based optical code reader has lower spatial resolution than the monochrome-imager-based optical code reader due to the color interpolation process. Alternatively, the typical color-imager-based optical code reader will have more total pixels than the monochrome-imager-based optical code reader to compensate for the degrading effects of the color interpolation process.

### SUMMARY OF THE DISCLOSURE

This disclosure describes improved optical code readers and associated methods.

One embodiment discloses a method of processing image data that represent light intensity values sensed by different pixels of a color image sensor array used in an optical code reader to improve edge location detection accuracy of optical code elements. The color image sensor array includes first and second sets of pixels. The pixels of the first and second sets are arranged along multiple parallel axes of a first axes group and along multiple parallel axes of a second axes group transverse to the first axes group in a checkerboard pattern. The first set of pixels and the second set of pixels are sensitive to visible wavelength bands of light that are different from one another. The pixels of the first set sense light reflected from an optical code that is positioned within a field of view of the optical code reader. The reflected light forms an image of the optical code on the color image sensor array. The image includes a pattern of dark and light elements that have edges to be detected that are oriented to be appreciably parallel to the axes of the first axes group. A first set of image data representing intensity values sensed by the first set of pixels is produced, and a second set of image data is produced from the first set of image data. The second set of image data represents interpolated intensity values that correspond to locations of selected pixels of the second set. For each location of a selected pixel of the second set, a corresponding interpolated intensity value is produced by using only intensity values sensed by pixels of the first set that share an axis of the first axes group with the selected pixel to thereby preserve spatial resolution along the second axes group and improve location detection accuracy of the edges of the dark and light elements of the optical code.

Additional aspects and advantages will be apparent from the following detailed description of preferred embodiments, which proceeds with reference to the accompanying drawings.

### BRIEF DESCRIPTION OF THE DRAWINGS

FIG. 1 is a diagram showing a Bayer pattern of a color filter array.

FIG. 2 is a block diagram of an optical code reader according to an embodiment.

FIG. 3 is a diagram showing a color image sensor array used in the optical code reader of FIG. 2, together with multiple axes corresponding to columns and rows of pixels of the color image sensor array.

FIGS. 4, 5, and 6 are examples of different optical codes that may be read by the optical code reader of FIG. 2.

FIG. 7 shows the pixels of the color image sensor array, together with an image of a portion of an optical code, to demonstrate an interpolation method according to an embodiment.

FIG. 8 shows an image of a portion of an optical code superimposed on, and rotated with respect to, the multiple axes of FIG. 3.

FIG. 9 is a flow chart of the steps of an interpolation method according to an embodiment.

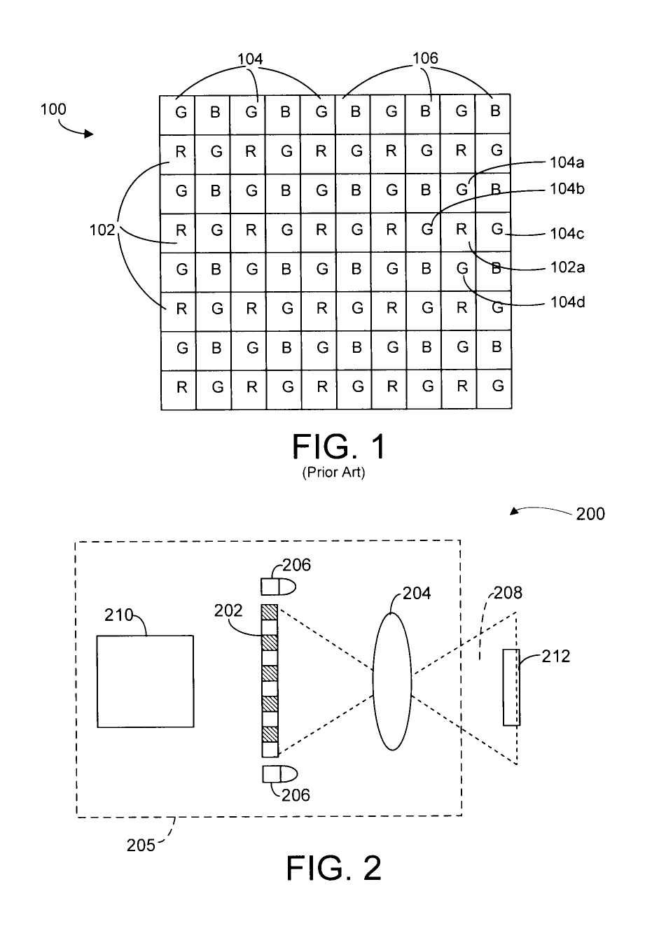

### DETAILED DESCRIPTION OF THE EMBODIMENTS

With references to the above-listed drawings, this section describes particular embodiments and their detailed construction and operation.

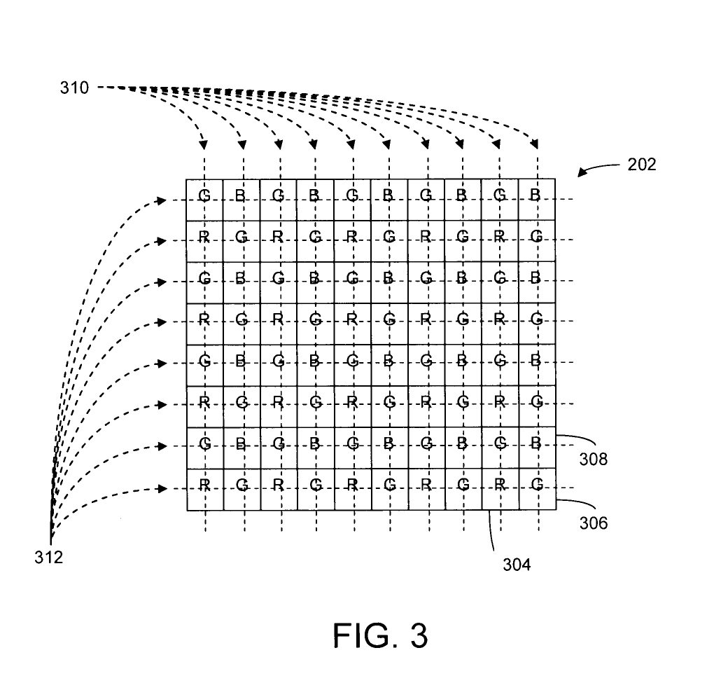

FIG. 2 is a block diagram of an optical code reader 200 according to one embodiment. The optical code reader 200 may be any type of reader, such as, but not limited to, a hand-held type reader, a stationary reader, or a personal digital assistant (PDA) reader. The optical code reader 200 includes a color image sensor array 202 of red pixels 304, green pixels 306, and blue pixels 308 shown in FIG. 3. The color image sensor array 202 may be a charge-coupled device (CCD), such as a full-frame, frame-transfer, or interline-transfer CCD. Alternatively, the color image sensor array 202 may be a complementary metal oxide semiconductor (CMOS) imager, such as a global shuttered or rolling-reset CMOS imager.

The red, green, and blue pixels 304, 306, and 308 of the color image sensor array 202 are arranged along multiple parallel axes of a first axes group 310 and along multiple parallel axes of a second axes group 312 transverse to the first axes group 310 in a Bayer pattern. The green pixels 306 are positioned at every other pixel location to form a checkerboard pattern with a combination of the red pixels 304 and blue pixels 308. FIG. 3 illustrates the first and second axes groups 310 and 312 and the pixels 304, 306, and 308 of the color image sensor array 202. In the color image sensor array 202, each axis of the first axes group 310 corresponds to a column of red and green pixels 304 and 306 or blue and green pixels 308 and 306, and each axis of the second axes group 312 corresponds to a row of red and green pixels 304 and 306 or blue and green pixels 308 and 306. Each row of pixels corresponds to a scan line of the color image sensor array 202. Alternatively, the first axes group 310 may correspond to the rows of pixels (i.e., the scan lines), and the second axes group 312 may correspond to the columns of pixels. FIG. 3 shows ten columns (i.e., ten parallel axes of the first axes group 310) and eight rows (i.e., eight parallel axes of the second axes group 312). The color image sensor array 202, however, may contain many more columns and rows than the numbers of columns and rows shown in FIG. 3. For example, color image sensor array 202 may contain one or more megapixels.

The red pixels 304 of color image sensor array 202 are sensitive to visible light having wavelengths that correspond to the color red (wavelengths ranging between about 600 nanometers (nm) and about 750 nm). The green pixels 306 are sensitive to visible light having wavelengths that correspond to the color green (wavelengths ranging between about 500 nm and about 600 nm). The blue pixels 308 are sensitive to visible light having wavelengths that correspond to the color blue (wavelengths ranging between about 400 nm and about 500 nm). The red, green, and blue pixels 304, 306, and 308 produce image data representing light intensities sensed by the pixels.

The optical code reader 200 includes an optical system 204 positioned to focus light on the color image sensor array 202. The optical system 204 may include conventional optical components, such as one or more lenses, an aperture, and, in some cases, a mechanical shutter. As an alternative to a mechanical shutter, the color image sensor array 202 may include electronic shuttering means.

The optical code reader 200 may include one or more artificial illumination sources 206 positioned to illuminate a field of view 208 of the optical code reader 200 (two artificial illumination sources are shown in FIG. 2). Alternatively, the optical code reader 200 may rely on ambient light to illuminate the field of view 208 instead of the artificial illumination sources 206.

The optical code reader 200 includes a data processing system 210. The data processing system 210 may include conventional hardware, such as camera interface hardware, and one or more programmable central processing units (CPU). The data processing system 210 may also include a field programmable gate array (FPGA) for performing various operations described below (e.g., pixel selection, interpolation, edge detection) to reduce the loading of other processor-based stages and, thus, allow for higher pixel rate processing or slower processor speeds. An FPGA may also implement spatial filtering of images using, for example, one-dimensional or two-dimensional convolution kernels for improving a signal-to-noise ratio (by reducing noise using a low-pass or band-pass filter), or for sharpening an image using a high-pass filter. Filters implemented by an FPGA may also be used to compute signal values between pixel sites to produce higher resolution interpolated images. Alternatively, or in addition, to an FPGA, the data processing system may include various types of programmable or non-programmable logic hardware, such as a complex programmable logic device (CPLD), a masked logic array, a standard cell, and a full custom application specific integrated circuit (ASIC), to perform the various operations.

The data processing system 210 may be contained within a housing 205 of the optical code reader 200. Alternatively, the data processing system 210 may be external to the housing 205 of the optical code reader 200, the data processing system 210 and the optical code reader 200 may communicate through a wired (e.g., EIA232, USB) or wireless (e.g., WLAN, Bluetooth®) communication link, and the data processing system 210 may communicate simultaneously with multiple optical code readers 200.

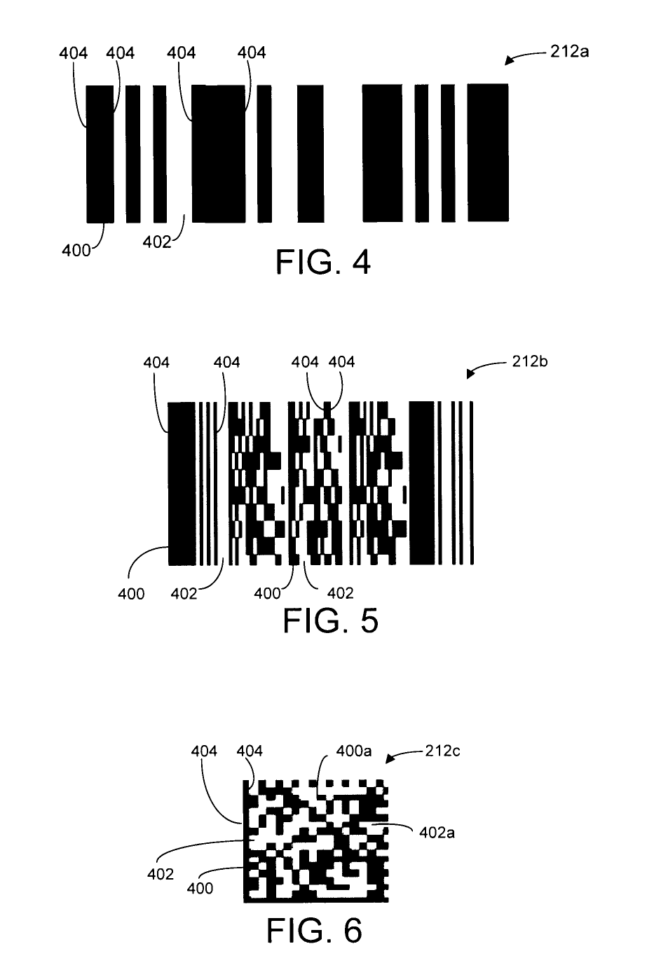

FIG. 2 shows an optical code 212 in the field of view 208 of the optical code reader 200. The optical code reader 200 may read any type of optical code such as one-dimensional optical codes and higher-dimensional optical codes. FIGS. 4, 5, and 6 show three different examples of the types of optical codes that may be read by the optical code reader 200. FIG. 4 shows an example of a linear bar code 212a; FIG. 5 shows an example of a stacked code 212b; and FIG. 6 shows an example of matrix code 212c. Each code 212a, 212b, and 212c includes a pattern of dark elements 400 (e.g., bars) and light elements 402 (e.g., spaces). The dark and light elements 400 and 402 include demarcation edges 404 to be detected by the optical code reader 200. With respect to the matrix code 212c, in addition to detecting the demarcation edges 404, dark cells 400a and light cells 402a are to be classified as dark or light without the need to precisely locate the edges of each cell. It may be useful, however, to locate the edges of at least some of the dark and light cells 400a and 402a to provide additional information for identifying the locations of at least some of the cells.

In operation, the optical code 212 is positioned in, or passed through, the field of view 208 of the optical code reader 200. The field of view 208 of the optical code reader 200 may be illuminated by artificial light generated by artificial illumination sources 206 or by ambient light. The light that illuminates the field of view 208 includes light having wavelengths that correspond to the color green. The light reflects off the optical code 212 toward the optical system 204. The optical system 204 focuses the reflected light on the pixels of the color image sensor array 202—the focused light forming an image of the optical code 212 on the pixels. A first set of image data representing the intensities values of light sensed by the green pixels 306 is transmitted to the data processing system 210. The data processing system 210 uses the first set of image data to produce a second set of image data representing interpolated intensity values for red and blue pixel locations. The first and second sets of image data are used to decode the optical code 212 (e.g., detect the edges 404 of the dark elements 400 and light elements 402, classify cells as dark or light). The red pixels 304 and the blue pixels 308 may also produce image data representing the intensities values of light sensed by the red and blue pixels 304 and 308. The image data produced by the red and blue pixels 304 and 308, however, may be replaced by the second set of image data or ignored. The image data produced by the red and blue pixels 304 and 308 may be retained for other purposes such as providing a color image on a display for human viewing.

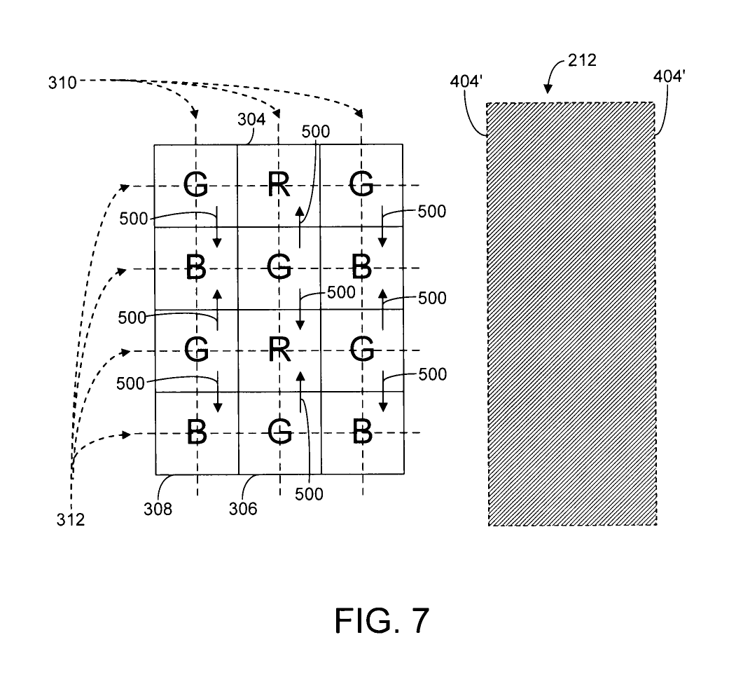

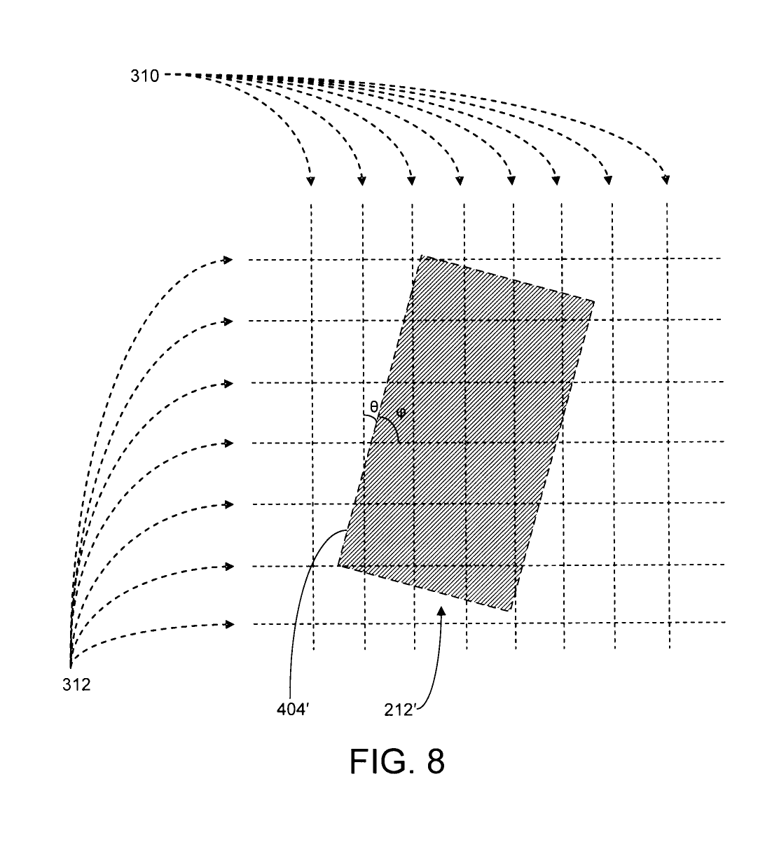

Orientations of the optical code 212 and the parallel axes of the first and second axes groups 310 and 312 will now be described. FIG. 7 shows a portion of the pixels 304, 306, and 308 of the color image sensor array 202 and an image 212′ of a portion of the optical code 212 that is formed on the color image sensor array 202. For clarity, the image 212′ is shown to the side of—rather than over—the pixels 304, 306, and 308. The optical code 212 is positioned in the field of view 208 so that edges 404′ of the image 212′ are appreciably parallel to the axes of the first axes group 310 (i.e., the columns of the pixels). The edges 404′ being “appreciably parallel” to the axes of the first axes group 310 means that the smallest angle θ between the edges 404′ and the axes of the first axes group 310 is less than the smallest angle φ between the edges 404′ and the axes of the second axes group 312 as shown in FIG. 8. In other words, “appreciably parallel” includes any orientation in which the smallest angle θ between the edges 404′ and the axes of the first axes group 310 ranges from about 0° to about 45°. The optical code 212 may be positioned in the field of view 208 to achieve the above-described alignment by moving (e.g., rotating) the optical code 212 and/or the optical code reader 200.

Production of the interpolated intensity values according to one embodiment will now be described in more detail. The interpolated intensity values correspond to selected locations of the red pixels 304 and the blue pixels 308. For a selected location, an interpolated intensity value is produced using only the intensity values of the green pixels 306 located along the axis of the first axes group 310 (i.e., the intensity values of the green pixels 306 that share an axis of the first axes group 310 with the selected location). In other words, the data processing system 210 performs single-axis interpolation—the axis of interpolation corresponding to the orientation of the edges 404′ of the image 212′ of the optical code 212. For example, FIG. 7 shows arrows 500 representing the intensity values of the green pixels 306 that are used to produce the interpolated intensity values for different locations of the red and blue pixels 304 and 308. For the red pixel 304 located in the second column and third row, the intensity values of the green pixels 306 located above (i.e., second column and second row) and below (i.e., second column and fourth row) are used to produce the interpolated intensity value for the red pixel location. The same interpolation method is used to produce interpolated intensity values for red and blue pixels locations along consecutive rows (i.e., along consecutive axes of the second axes group 312).

By using only the intensity values of green pixels 306 located along axes appreciably parallel to the edges of optical codes to produce interpolated intensity values, the locations of the edges of optical codes are preserved more accurately compared to methods that interpolate across the edges of optical codes. In other words, the above-described method preserves spatial resolution of the color image sensor array 202 along the parallel axes of the second axes group 312 so that the locations of the edges of optical codes may be accurately identified. Thus, the above-described method allows the color image sensor array 202 to achieve a spatial resolution across optical code edges that is comparable to that achieved by a monochrome imager having the same number of pixels as the sum of the red, green, and blue pixels 304, 306, and 308. In addition, by using only information from the green pixels 306 to read the optical code 212, problems associated with, and the need to compensate for, differences in sensitivity between the red pixels 304, green pixels 306, and blue pixels 308 may be avoided.

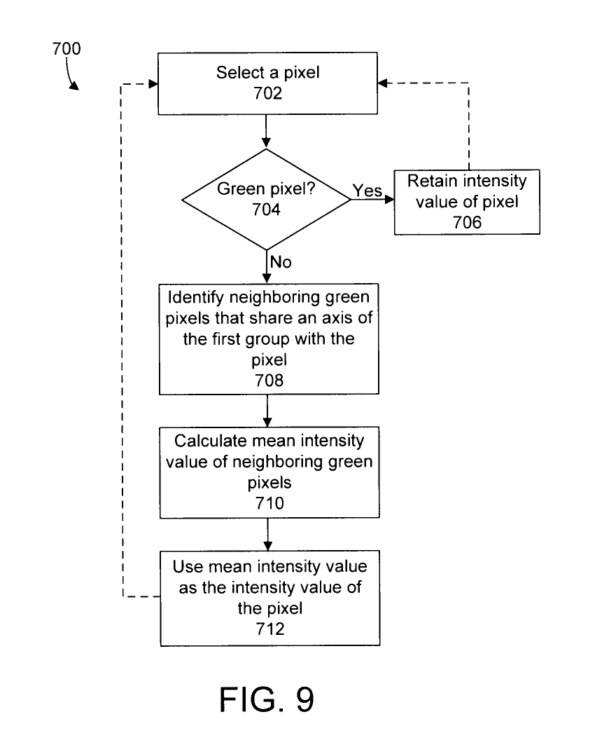

FIG. 9 is a flow chart of steps of a particular method 700 that may be implemented by the optical code reader 200. After receiving the image data from the green pixels 306, together with the image data from the red and blue pixels 304 and 308, the data processing system 210 selects a pixel by identifying a portion of the image data that corresponds to the selected pixel (step 702). The data processing system 210 identifies whether the selected pixel is a green pixel 306 (step 704). If the selected pixel is a green pixel 306, the intensity value of the green pixel 306 is preserved to decode the optical code 212 (step 706).

If the selected pixel is a red pixel 304 or a blue pixel 308, the intensity value is ignored or discarded, and the data processing system 210 identifies the neighboring green pixels 306 that share an axis of the first axes group 310 with the selected pixel (step 708). For example, for the blue pixel 308 in the first column and second row of FIG. 7, the green pixels 304 above and below it (i.e., the green pixel 306 in the first column, first row and the green pixel 304 in the first column, third row) are used. The data processing system 210 uses the intensity values of the neighboring green pixels 306 to calculate a mean intensity value of the intensity values of the neighboring green pixels 306 (step 710) (e.g., mean intensity value=(I₁+I₂)/2, where I₁ is the intensity value of the first neighboring green pixel 306 and I₂ is the intensity value of the second neighboring green pixel 306). The mean intensity value is used as the interpolated intensity value for the selected pixel (step 712). The above-described steps are repeated for each pixel (represented by dashed lines extending from steps 706 and 712 to step 702), and the green pixel values of the green pixels 306 and the interpolated intensity values of the red and blue pixel locations are collectively used to decode the optical code 212.

The data processing system 210 need not perform all the above-described steps, and the data processing system 210 may perform alternative steps. For example, although linear interpolation has been described, the data processing system 210 may perform other known interpolation methods using one or more green pixels 306 located along the parallel axes of the first axes group 310 (i.e., other more computationally complex interpolation methods may be used to achieve higher levels of accuracy such as polynomial or spline interpolation). Additional information about various interpolation methods can be found in WILLIAM K. PRATT, DIGITAL IMAGE PROCESSING, 113-116 (John Wiley & Sons 1978) and Erik Meijering, A Chronology of Interpolation: From Ancient Astronomy to Modern Signal and Image Processing, 90 PROCEEDINGS OF THE IEEE 319-42 March 2002, the entire contents of which are incorporated herein by reference.

For some locations of the red and blue pixels 304 and 308, interpolated intensity values may not be produced (i.e., some locations are not selected locations). For example, for a color image sensor array 202 with n parallel axes of the second axes group 312 (i.e., n rows), interpolated intensity values need not be produced for red or blue pixels located along the first axis of the second axes group 312 (e.g., the top edge row of the color image sensor array 202) and the nth axis of the second axes group (e.g., the bottom edge row of the color image sensor array 202). In one embodiment, the intensity values of the green pixels 306 are the only intensity values used from the top edge and bottom edge rows to read the optical code 212. Alternatively, the intensity values of the top edge and bottom edge rows may not be used to decode the optical code 212.

Although the system and method described above correspond to an example where the image 212′ of the optical code 212 is oriented in a picket fence orientation, the image 212′ of the optical code 212 may also be oriented in a ladder orientation. With the ladder orientation, the parallel axes of the first axes group 310 correspond to the rows of pixels and interpolation is performed using the green pixels 306 of the rows instead of the green pixels of the columns so that spatial resolution in a direction across the edges 404′ of the image 212′ may be preserved.

In an alternative embodiment, the single-axis interpolation described above is performed along the axes of the first axes group 310 and then along the axes of the second axes group 312 so that two sets of interpolated intensity values are produced. The two sets of interpolated intensity values may be produced from the same set of green intensity values (e.g., a single frame) or from different sets of green intensity values (e.g., different frames). The sets of interpolated intensity values are used independently, in combination with the corresponding set of green intensity values, to identify the edges of the optical code 212 and, thereby, decode it. In other words, two interpolated images (including green intensity values and interpolated intensity values) are computed, one using vertical interpolation and the other using horizontal interpolation, and each interpolated image may be decoded independently.

For example, after capturing an image of the optical code 212, in a first processing round, the data processing system 210 performs the method 700 for each pixel of the color image sensor array 202 (note, the pixels of the first and nth rows need not be processed); then, in a second processing round, the data processing system 210 performs the method 700 for each pixel of the color image sensor array (again, the pixels of the first and nth rows need not be processed) with the exception that in steps 708 and 710, the neighboring green pixels 306 that share an axis of the second axes group 312 with the selected pixel are identified and their intensity values are used to produce the mean intensity value (e.g., for the red pixel 304 in the second column, third row of FIG. 7, the green pixels 306 to the right and left of it are used). Alternatively, instead of performing two processing rounds (one for vertical interpolation and one for horizontal interpolation), one processing round may be performed in which a vertical interpolation value and a horizontal interpolation value are created for a blue or red pixel location before processing a next pixel. The data processing system 210 may then attempt to decode the optical code 212 using one of the two interpolated images or both interpolated images.

By independently generating two interpolated images—one reflecting horizontal interpolation and the other reflecting vertical interpolation—locations of the edges 404 of the optical code 212 may be accurately identified regardless of the orientation of the optical code 212 (e.g., picket fence or ladder). Moreover, the optical code reader 200 need not attempt to determine the orientation of the optical code 212 prior to interpolating and decoding. For example, labels on packages and/or other optical codes within the field of view 208 of the optical code reader 200 may make it difficult for the optical code reader 200 to determine, prior to decoding, the orientation of the optical code 212 (e.g., the edges of symbols on packaging labels may dominate over those of the optical code 212 when attempting to use conventional edge detection techniques (e.g., gradient computation) to determine the orientation of the optical code 212). The data processing system 210 may operate relatively quickly so that it generates the interpolated images and attempts to decoded them without significantly increasing the processing time.

Alternatively, the data processing system 210 may analyze the interpolated images to determine which interpolated image to decode. The interpolated images may be compared (e.g., edge sharpness comparison) to identify the interpolated image that most accurately reflects the locations of the optical code edges 404. Several possible measures of the amount of signal modulation may be implemented to choose the interpolated image that is most likely to have been interpolated in a direction substantially parallel to the edges 404 of the optical code 212. For example, one measurement may be standard deviation, in which the image is chosen that has the smallest standard deviation of pixel values along a row or column. Alternatively, a second measurement may be the differences between adjacent pixels, in which the image is chosen that has the smallest sum of the absolute values of the differences between adjacent pixels. The interpolated image that represents edges 404 in higher resolution may be selected for decoding. Choosing one of the interpolated images to decode—instead of decoding both interpolated images—may be useful in some applications.

The data processing system 210 may also use feedback information from a decoder implemented in the data processing system 210 to identify the orientation of the optical code 212 so that the optical code reader 200 can improve its performance during a subsequent read. For example, the decoder may be able to identify whether the optical code 212 is oriented in a picket fence or ladder orientation without being able to actually decode it. Accordingly, the decoder can communicate that the optical code 212 was in a particular orientation so that the data processing system 210 need only interpolate along either the first set of axes 310 or the second set of axes 312 during a subsequent attempt to read the optical code 212.

In the embodiments described above, green pixel data is used to compute interpolated intensity values and to decode the optical code 212. Skilled persons will recognize, however, that red pixel data, blue pixel data, or a combination of red and blue pixel data may be used in accordance with the above-described embodiments to compute interpolated intensity values corresponding to green pixel locations to decode the optical code 212.

Moreover, although the colors red, green, and blue and the Bayer pattern have been described above in connection with the color image sensor array 202, other colors and filter patterns may be used without departing from the scope and spirit of the present disclosure. For example, the color image sensor array 202 may include a cyan, yellow, green, and magenta (CYGM) filter; a red, green, blue, and emerald (RGBE) filter; or a white, red, green, and blue (WRGB) filter. The optical code reader 200 and its associated methods are flexible to compensate for the effects of these various filters. For example, single-axis interpolation may be conducted using one or more of the colors of these different filters.

Certain embodiments may be capable of achieving one or more of the following advantages: (1) enabling utilization of lower cost color imagers in optical code readers; (2) achieving higher spatial resolution with a color imagers by interpolating along—not across—optical code edges; (3) reducing processor loading to allow for higher pixel rate processing or lower processor speeds by performing various operations via an FPGA; and (4) reading higher density optical codes than would otherwise be possible.

Though the present invention has been set forth in the form of its preferred embodiments, it is nevertheless intended that modifications to the disclosed systems and methods may be made without departing from inventive concepts set forth herein.

1. A method of processing image data representing light intensity values sensed by different pixels of a color image sensor array used in an optical code reader, the color image sensor array including first and second sets of pixels, the pixels of the first and second sets being arranged along multiple parallel axes of a first axes group and along multiple parallel axes of a second axes group transverse to the first axes group, the first set of pixels being sensitive to light within a first wavelength band and at least some of the pixels of the second set being sensitive light within a second wavelength band that is different from the first wavelength band, comprising:
sensing with the first set of pixels light reflected from an optical code positioned within a field of view of the optical code reader, the reflected light forming an image of the optical code on the color image sensor array, and the image of the optical code including a pattern of dark and light elements that have edges to be detected that are oriented to be appreciably parallel to the axes of the first axes group;
producing a first set of image data representing intensity values sensed by the first set of pixels; and
producing from the first set of image data a second set of image data representing interpolated intensity values that correspond to locations of selected pixels of the second set, wherein for each location of a selected pixel, a corresponding interpolated intensity value is produced by using only intensity values sensed by pixels of the first set that share an axis of the first axes group with the location of the selected pixel.

2. The method of claim 1, producing interpolated intensity values for locations of selected pixels that are along consecutive axes of the second axes group.

3. The method of claim 1, in which the first wavelength band corresponds to the color green, and the sensing step further comprises sensing green light with the first set of pixels.

4. The method of claim 3, in which the second set of pixels includes a first subset of pixels that are sensitive to light within the second wavelength band and a second subset of pixels that are sensitive to light within a third wavelength band, the second wavelength band corresponding to the color red and the third wavelength band corresponding to the color blue, further comprising:
sensing red light with the first subset of pixels;
sensing blue light with the second subset of pixels;
producing a third set of image data representing intensity values sensed by the first and second subsets of pixels; and
replacing the intensity values represented in the third set of image data with the interpolated intensity values.

5. The method of claim 1, in which the image of the optical code is oriented in a picket fence orientation and each parallel axis of the first axes group corresponds to a column of pixels, further comprising:
for each selected pixel,
identifying neighboring pixels of the first set that are located in the column of, and adjacent to, the selected pixel;
calculating a mean intensity value from the intensity values sensed by the neighboring pixels; and
assigning the mean intensity value as the interpolated intensity value that corresponds to the location of the selected pixel.

6. The method of claim 1, in which the image of the optical code is oriented in a ladder orientation and each parallel axis of the first axes group corresponds to a row of pixels, further comprising:
for each selected pixel,
identifying neighboring pixels of the first set that are located in the row of, and adjacent to, the selected pixel;
calculating a mean intensity value from the intensity values sensed by the neighboring pixels; and
assigning the mean intensity value as the interpolated intensity value that corresponds to the location of the selected pixel.

7. The method of claim 1, in which the second axes group includes n axes, and interpolated intensity values are not produced for locations of the pixels of the second set along the first and nth axes of the second axes group.

8. The method of claim 1, further comprising analyzing the first and second sets of image data to detect the edges of the dark and light elements.

9. A method of improving edge location detection accuracy of an optical code reader having a color image sensor array of red, green, and blue pixels sensitive to, respectively, red, green, and blue wavelengths of light, the red, green, and blue pixels being arranged along multiple parallel axes of a first axes group and along multiple parallel axes of a second axes group transverse to the first axes group in a Bayer pattern, the method comprising:
sensing with the green pixels light reflected from an optical code positioned within a field of view of the optical code reader, the reflected light forming an image of the optical code on the color image sensor array, and the image of the optical code including a pattern of light and dark elements that have edges to be detected that are oriented to be appreciably parallel to the axes of the first axes group;
producing green pixel values representing light intensities sensed by the green pixels; and
performing single-axis interpolation of the green pixel values to produce interpolated pixel values that correspond to selected locations of the blue pixels and the red pixels, wherein for each selected location, a corresponding interpolated pixel value is produced by using only green intensity values of green pixels that share an axis of the first axes group with the selected location to thereby preserve spatial resolution along the axes of the second axes group and improve location detection accuracy of the edges of the dark and light elements of the optical code.

10. The method of claim 9, further comprising:
for each selected location,
identifying neighboring green pixels that share an axis of the first axes group with the selected location and that are adjacent to the selected location;
calculating a mean pixel value of the green pixel values of the neighboring green pixels; and
assigning the mean pixel value as the interpolated pixel value that corresponds to the selected location.

11. The method of claim 9, in which the image of the optical code is oriented in a picket fence orientation and each parallel axis of the first axes group corresponds to a column of pixels.

12. The method of claim 9, in which the image of the optical code is oriented in a ladder orientation and each parallel axis of the first axes group corresponds to a row of pixels.

13. An optical code reader comprising:
a color image sensor array that includes red, green, and blue pixels arranged along multiple parallel axes of a first axes group and along multiple parallel axes of a second axes group transverse to the first axes group in a Bayer pattern, the red, green, and blue pixels being sensitive to, respectively, red, green, and blue wavelengths of light, the green pixels being operative to produce green pixel values representing sensed light intensities;
an optical system positioned between the color image sensor array and a field of view of the optical code reader for focusing on the color image sensor array an image of an optical code that includes dark and light elements with edges to be detected that are oriented to be appreciably parallel to the axes of the first axes group; and
a single-axis interpolator that receives the green pixel values from the color image sensor array and produces from the green pixel values interpolated pixel values that correspond to selected locations of the blue pixels and the red pixels, wherein for each selected location, the single-axis interpolator using only green pixel values of green pixels that share an axis of the first axes group with the selected location to produce the corresponding interpolated pixel value.

14. The optical code reader of claim 13, further comprising a field programmable gate array in which the single-axis interpolator is implemented.

15. The optical code reader of claim 13, in which each parallel axis of the first axes group corresponds to a column of pixels and each parallel axis of the second axes group corresponds to a row of pixels.

16. The method of claim 15, in which a column includes a first pixel and a second pixel, and the first and second pixels correspond to different scan lines of the color image sensor array.

17. The optical code reader of claim 13, in which the single-axis interpolator calculates a mean pixel value from neighboring green pixels that share an axis of the first axes group with the selected location and that are adjacent to the selected location, the mean pixel value being the interpolated pixel value that corresponds to the selected location.

18. The method of claim 13, in which the optical code is selected from a group consisting of a linear bar code, a stacked bar code, and a matrix code.

19. A method of imaging in an optical code reader having a color image sensor array of a first set of pixels and a second set of pixels, the first and second sets of pixels being arranged along multiple parallel axes of a first axes group and along multiple parallel axes of a second axes group transverse to the first axes group, the first set of pixels being sensitive to light within a first wavelength band, and at least some of the pixels of the second set being sensitive to light within a second wavelength band that is different from the first wavelength band, comprising:
sensing with the first set of pixels light reflected from an optical code positioned within a field of view of the optical code reader, the reflected light forming an image of the optical code on the color image sensor array, and the image of the optical code including dark and light elements having edges to be detected that are oriented to be appreciably parallel to the axes of one of the first and second axes groups;
producing a first set of image data representing intensity values sensed by the first set of pixels;
performing single-axis interpolation of the intensity values along axes of the first axes group to produce a first set of interpolated pixel values that correspond to selected locations of the pixels of the second set, the first set of interpolated intensity values and the intensity values representing a first interpolated image of the optical code; and
performing single-axis interpolation of the intensity values along axes of the second axes group to produce a second set of interpolated pixel values that correspond to the selected locations of the pixels of the second set, the second set of interpolated intensity values and the green pixel values representing a second interpolated image of the optical code.

20. The method of claim 19, wherein, for each selected location, a corresponding interpolated pixel value of the first set is produced by using only intensity values of pixels of the first set that share an axis of the first axes group with the selected location.

21. The method of claim 19, wherein, for each selected location, a corresponding interpolated pixel value of the second set is produced by using only intensity values of pixels of the first set that share an axis of the second axes group with the selected location.

22. The method of claim 19, further comprising decoding the first interpolated image and the second interpolated image independently of each other, the first and second interpolated images including representations of the demarcation edges of the optical code, wherein one of the first and second interpolated images includes higher-resolution representations of the edges than the other one of the interpolated images dependent on the orientation of the optical code.
